(19) United States
(12) Patent Application Publication
(10) Pub. No.: US 2008/0140610 A1
(43) Pub. Date: Jun. 12, 2008

(54) System and method for repurposing printed content to interact with digital content

(76) Inventors: Jason E. Barkeloo, Cincinnati, OH (US); David A. Krauth, Manchester, NH (US)

Correspondence Address: TAFT, STETTINIUS & HOLLISTER LLP, SUITE 1800, 425 WALNUT STREET, CINCINNATI, OH, 45202-3957, US

(21) Appl. No.: 11/974,193

(22) Filed: Oct. 11, 2007

Related U.S. Application Data
(60) Provisional application No. 60/850,984, filed on Oct. 11, 2006.

(51) Int. Cl. G06F 17/30

(52) U.S. Cl. 707/2; 707/E17.005

(57) ABSTRACT

It is a first aspect of the present invention to provide a method of repurposing printed content to interact with digital content including the steps of: providing printed content items and digital content items associated with the printed content items, providing an interactive user device capable of associating printed content items with one or more of the digital content items, accessing a mapping database by the interactive user device, the mapping database having mapping information related to the mapping of printed content items to digital content items, and modifying the mapping information to associate the printed content items with alternate digital content items.

### CROSS-REFERENCE TO RELATED APPLICATIONS

This application claims the benefit of U.S. Provisional Application Ser. No. 60/850,984, entitled “SYSTEM FOR REPURPOSING PRINTED CONTENT TO INTERACT WITH DIGITAL CONTENT,” filed on Oct. 11, 2006, the disclosure of which is incorporated herein by reference.

### FIELD OF THE INVENTION

The present invention relates to a system and method of repurposing printed content to interact with digital content. Specifically, the present invention involves modifying the representation of a digital file and associating representations of the digital file with printed content.

### BACKGROUND OF THE INVENTION

Innovations have begun to transform conventional books and other printed publications into multimedia interactive devices. Printed publications have been fitted to connect electronically with computers and other media storage devices to retrieve and display digital content. In some instances, the printed publications have an integrated remote control device capable of interacting wirelessly with the media storage devices and in other instances, the printed publications are tethered to the media storage devices with a local connection such as a USB connection or cable connection. This technology enables, for example, a reader to press the pictures and words on the regular printed ink and paper page and retrieve digital content from a computer or other media storage device.

Creators and publishers of content for use with these multimedia interactive devices may desire to make their content available in various formats for different audiences. In creating this content, the content may need to be modified from one format to another in order to satisfy a user's needs. There is currently a need to allow creators and publishers to repurpose printed content to interact with various formats of the same digital content. The present invention desires to fulfill that need.

### SUMMARY OF THE INVENTION

The present invention solves the above problem by providing a system and method allowing the modification of digital content and associating representations of the digital file with printed content.

It is a first aspect of the present invention to provide a method of repurposing printed content to interact with digital content including the steps of: providing printed content items and digital content items associated with the printed content items, a storage device storing a content database having a plurality of digital content items, an output device for outputting one or more representations of the plurality of digital content items, and an interactive user device for generating one or more signals associated with retrieval of the plurality of digital content items from the storage device based, at least in part, on input of a user, the interactive user device being capable of associating the printed content items with one or more of the digital content items; accessing a mapping database by the interactive user device, the mapping database having mapping information related to the mapping of printed content items to digital content items; converting the digital content items to alternate digital content items using a software application; modifying the mapping information to associate the printed content items with the alternate digital content items in response to, at least in part, input from the user; and outputting to the output device the alternate digital content items.

In one embodiment of the first aspect, the mapping information includes one of a database file and a database record. In one embodiment, the digital content items may include audio content, video content, text content, picture content, graphic content, mathematics content, scientific content, sign language content, animation content, email content and/or Internet content. In one embodiment, the alternate digital content items may include audio content, video content, text content, picture content, graphic content, mathematics content, scientific content, sign language content, animation content, email content and/or Internet content. In one embodiment of this aspect, the printed content item includes an icon associated with one or more of audio content, video content, text content, picture content, graphic content, mathematics content, scientific content, sign language content, animation content, email content and Internet content. Furthermore, one embodiment further includes the step of displaying the printed content item within a printed publication, the printed content items including an icon. In one embodiment, the icon includes an icon associated with one or more of audio content, video content, text content, picture content, graphic content, mathematics content, scientific content, sign language content, animation content, email content and Internet content.

It is a second aspect of the present invention to provide a method of repurposing printed content to interact with digital content including the steps of: providing a printed content item and a digital content item, a storage device storing a content database having a digital content item, an output device for outputting one or more representations of the digital content item, a software application for converting the digital content item to an alternate representation of the digital content item, and an interactive user device for generating one or more signals associated with retrieval of the digital content item from the storage device based, at least in part, on input of a user, the interactive user device being capable of associating the printed content item with the digital content item; associating via a mapping database the printed content item with the digital content item; initiating by a user the software application to convert the digital content item to the alternate representation of the digital content item; converting the digital content item to the alternate representation of the digital content item; modifying the mapping database to associate the printed content item with the alternate representation of the digital content item in response to, at least in part, input from the user; and outputting to the output device alternate representation of the digital content item.

In one embodiment of this aspect, the digital content item may include audio content, video content, text content, picture content, graphic content, mathematics content, scientific content, sign language content, animation content, email content and/or Internet content. In one embodiment, the alternate representation of the digital content item may include audio content, video content, text content, picture content, graphic content, mathematics content, scientific content, sign language content, animation content, email content and/or Internet content. In one embodiment of this aspect, the printed content item includes an icon associated with one or more of audio content, video content, text content, picture content, graphic content, mathematics content, scientific content, sign language content, animation content, email content and Internet content. Furthermore, one embodiment further includes the step of displaying the printed content item within a printed publication, the printed content items including an icon. In one embodiment, the icon includes an icon associated with one or more of audio content, video content, text content, picture content, graphic content, mathematics content, scientific content, sign language content, animation content, email content and Internet content.

It is a third aspect of the present invention to provide a system for repurposing printed content to interact with digital content including a printed publication having a printed content item, a storage device for storing a first digital content item and a second digital content item, a content database adapted to associate the printed content item with the first digital content item, the content database being capable of being modified to re-associate the printed content item with the second digital content item, an interactive user device adapted to request one or more of the first digital content item and the second digital content item from the content database, and an output device for outputting a representation of the one or more of the first digital content item and the second digital content item.

In one embodiment of this aspect, the system further includes a software tool capable operating on one of the interactive user device and the output device, the software tool configured to perform the steps of: associating via the content database the printed content item with the first digital content item, and modifying the content database to associate the printed content item with the second digital content item. In one embodiment of this aspect, the first digital content item may include audio content, video content, text content, picture content, graphic content, mathematics content, scientific content, sign language content, animation content, email content and/or Internet content. In one embodiment, the second digital content item may include audio content, video content, text content, picture content, graphic content, mathematics content, scientific content, sign language content, animation content, email content and/or Internet content. In one embodiment of this aspect, the printed content item includes icons associated with one or more of audio content, video content, text content, picture content, graphic content, mathematics content, scientific content, sign language content, animation content, email content and Internet content.

It is a fourth aspect of the present invention to provide a system for repurposing printed content to interact with digital content including a printed publication having a plurality of printed content items, a storage device for storing a plurality of digital content items associated with the plurality of printed content items, a content database for associating each of the plurality of printed content items with each of the plurality of digital content items, the content database being capable of modification to re-associate one of the plurality of printed content items with one of the plurality of digital content items, an interactive user device adapted to request one or more of the plurality of digital content items from the content database, and an output device for outputting one or more of the plurality of digital content items.

In one embodiment of this aspect, the system further includes a software tool operating on one of the interactive user device and the output device, the software tool configured to perform the steps of: associating via the content database the plurality of printed content item with the plurality of digital content items, and modifying the content database to re-associate at least on of the plurality of printed content items with at least one of the plurality of digital content items. In one embodiment of this aspect, the plurality of digital content items may include audio content, video content, text content, picture content, graphic content, mathematics content, scientific content, sign language content, animation content, email content and/or Internet content. In one embodiment of this aspect, the plurality of printed content items include icons associated with one or more of audio content, video content, text content, picture content, graphic content, mathematics content, scientific content, sign language content, animation content, email content and Internet content.

From the foregoing disclosure and the following detailed description of various preferred embodiments it will be apparent to those skilled in the art that the present invention provides a significant advance in the art. Additional features and advantages of various preferred embodiments will be better understood in view of the detailed description provided below.

### BRIEF DESCRIPTION OF THE DRAWINGS

The present invention will be understood and appreciated more fully from the detailed description in conjunction with the following drawings in which:

FIG. 1 is a diagram of an exemplary embodiment of an interactive hybrid printed material transmitting a signal to the host device.

FIG. 2 illustrates exemplary embodiments of icons corresponding to membrane switches for an exemplary interactive hybrid printed material in accordance with the present invention.

### DETAILED DESCRIPTION

It will be apparent to those skilled in the art that many uses and variations are possible for the system and method disclosed herein. The following detailed discussion of various alternative and preferred embodiments will illustrate the general principles of the invention. Other embodiments will be apparent to those skilled in the art given the benefit of this disclosure.

Recently, printed publications 10 have been fitted to connect electronically with computers 12 and other media output devices (such as display devices or audio devices) to retrieve and display digital content (such printed publications shall be referred to as “interactive hybrid printed material” or “IHPM”). In some instances, the IHPMs 10 have an integrated remote control device capable of interacting wirelessly with the media output devices (herein, a “remote interactive hybrid printed material” or “remote IHPM”), and in other instances, the IHPMs 10 are tethered to the media output devices with a local connection such as a USB connection or cable connection. This technology enables, for example, a reader to press the pictures, icons and words on the regular printed ink and paper page and retrieve digital content from a computer, storage device or other media output device. Examples of such IHPMs 10 are described in U.S. Pat. Nos. 5,624,265, 5,757,304, 5,749,735, 5,763,112, 5,788,507, 5,839,905, 5,911,582, 5,957,695, 6,327,459 and 6,650,867, the disclosures of which are incorporated by reference.

For example, a remote IHPM 10 generally includes a remote control circuitry, a printed publication having printed content, and a membrane switch connected to the remote control circuitry. The remote control circuitry is capable of transmitting a wireless signal to a host device 12 wherein an application running on the host device 12 displays the desired results. The membrane switch of the interactive hybrid printed material 10 has a visual association with printed text and/or graphic content on the remote control. The function and/or data indicated by the text and/or graphic content associated with the pressed membrane switch is used by a host device 12 in displaying associated electronic content. The associated electronic content is encoded in one or more remote storage media 14. The interactive hybrid printed material 10 allows a user to simply activate the membrane switch (e.g., push button or touch sensitivity pad) on the interactive hybrid printed material 10 to cause the host device 12 to access electronic content from a remote server 14 or storage device 14.

In accordance with the present invention, a system for repurposing printed content to interact with digital content is disclosed. As used herein, “repurposing” is the process of converting, modifying, or otherwise changing the presentation style or format of a digital file.

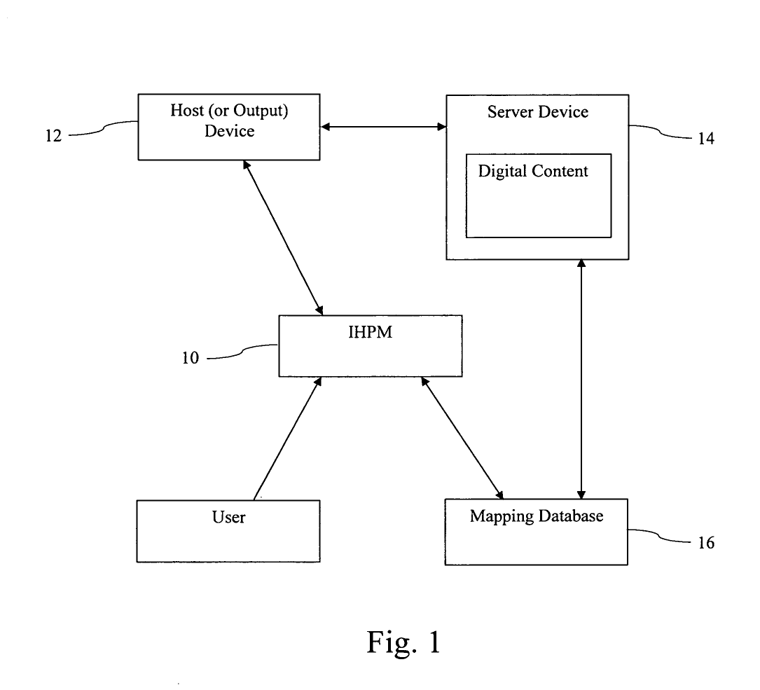

Referring to FIG. 1, an exemplary remote interactive hybrid printed material 10 includes a remote control circuitry, a printed publication having printed content, and a membrane switch (for example) connected to the remote control circuitry. The membrane switch may be any type of device capable of sensing and responding to pressure—for example, a push button, koala pad, or touch sensitivity pad. In an exemplary embodiment, the membrane switch of the interactive hybrid printed material 10 has a visual association with text and/or graphic content on the remote interactive hybrid printed material 10. The associated electronic content and the membrane switch have a remote electronic association implemented through a wireless signal encoded with the remote interactive hybrid printed material 10. It is also within the scope of the invention to utilize any alternative touch-sensing or location sensing device in place of the membrane switch.

An exemplary embodiment of the present invention may also utilize the locally connected interactive hybrid printed material 10 in place of the remotely connected device. The locally connected IHPM 10 likewise includes the printed publication having printed content and the membrane switch; however, in place of the remote control circuitry of the remote IHPM 10 is circuitry that transmits the touch location and other information over local connections.

When the user touches the text and/or graphics on the interactive hybrid printed material 10, pressure from the touch actuates the underlying membrane switch. In response to the activation of the membrane switch, the circuitry of the interactive hybrid printed material 10 generates and transmits a signal to a host device 12. As used herein, the term “host device” 12 is intended to mean any electronic device such as a computer, television, personal digital assistant, or cell phone that is able to output or display digital content. The signal from the remote interactive hybrid printed material 10 carries data (e.g., x and y coordinates) indicative of the touched location and/or the touched item on the interactive hybrid printed material 10.

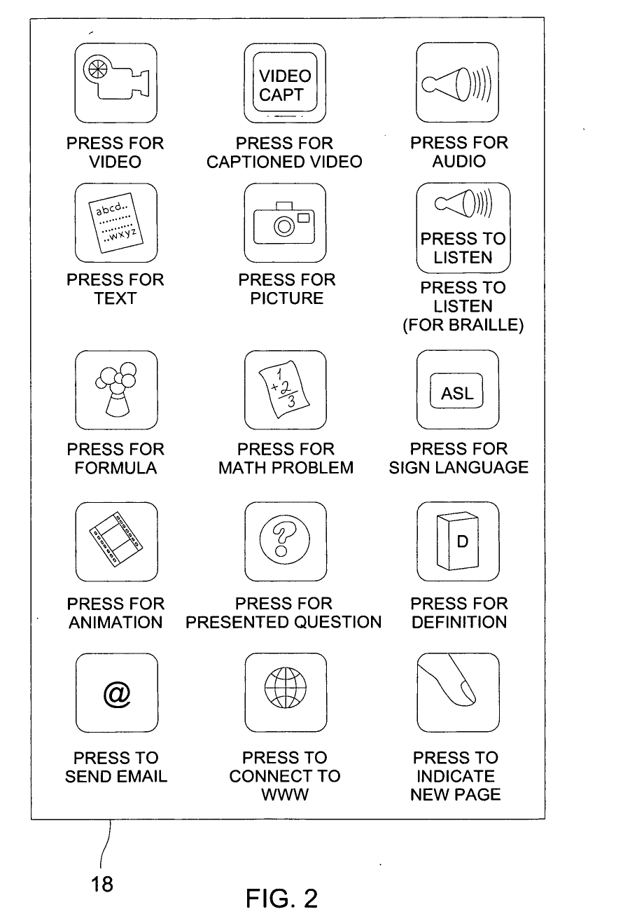

Referring to FIG. 2, icons 18 may be displayed on the printed publication to indicate what type of digital content is available for outputting or displaying. Upon a user touching one of these displayed icons 18 (or other actuation of the membrane switch) on the printed page, one or more forms of repurposing may occur. Exemplary icons 18 may include icons 18 associated with one or more of audio content, video content, text content, picture content, graphic content, mathematics content, scientific content, sign language content, animation content, email content and Internet content.

One such form of repurposing may include mapping or re-mapping the location of the digital content in a mapping database 16 or content database 16. In one embodiment, such a database 16 is provided such that the database 16 includes information records that show the location of the digital content items associated with the IHPM 10. Such a mapping database 16 may be located within the IHPM 10, host device 12 or storage device 14. In another embodiment, the mapping database 16 may be located at a networked location. The mapping database 16 may be implemented by any known method capable of storing, retrieving and managing data. In an exemplary embodiment, the mapping database 16 is a Structured Query Language (SQL) database. The database 16 may create and store one or more unique ID keys for each digital content item. These unique ID keys may include information such the location of the digital content item within the storage device. In response to a query, the database 16 may respond with the location of the digital content or any other requested information.

Although the original digital content file need not be transformed or converted, its location will still be mapped or included in the content or mapping database 16. In this manner, any request for the digital content item (via activated icon 18 or actuation of the membrane switch) can lookup the location of the digital content item. This file mapping process is required in order to retrieve digital content upon activation of the membrane switch on the IHPM 10. For example, the owner of digital video may want the digital video displayed in the original format (without compression or other modification) when the membrane switch is pressed. Although it may be outputted in the original format on the host device 12, the digital video is still retrieved by determining the location of the digital video as found in the content or mapping database 16.

Digital content (or modified digital content) may include audio content, video content, text content, picture content, graphic content, mathematics content, scientific content, sign language content, animation content, email content and/or Internet content. In one embodiment of the present invention, repurposing of digital content may occur when a software tool is applied to a text file to convert the text file to an audible format that may be to be read aloud from the host device (text to voice). In another embodiment, repurposing of digital content may occur when a software tool is applied to a text file to convert the text file to allow it to be displayed on the host device 12, such as a computer monitor (text to html).

Digital content may be modified or converted by using a software tool operating on the IHPM 10 or the host device 12. This software tool may include a commercially available software tool, a proprietary software tool, a website utility or any other software tool. For example, digital content may be processed through a PDF conversion software or Microsoft© Word software in to convert a text document to an audible format. This conversion function may be integrated in the software tool. Other software tools may parse through an existing document file and infer from the document formatting and/or contextual data to convert the document to a different format. Such a conversion may be implemented through several different known text conversion software tools. Such a software tool may create a new file from the original format during the conversion process. For example, after converting a document from text to voice, the original text file and the new audio file may be present. This new audio file may be saved for future reference of played back audibly on an audio output device.

In another embodiment of the present invention, repurposing may occur where a user of an interactive hybrid printed material 10 (either tethered or remote) presses or uses a pointer to activate the membrane switch on the device and an electronic response results in the presentation of a video, a captioned video, an audio, a text, a picture, a formula, a math problem, sign language, animation, a question presented, a definition, an email, a connection with the Internet, and/or a new page that once was shown simply as an icon 18 (or other visual identification) integrated on the printed page.

The apparatuses, uses, and methods disclosed herein have been described without reference to specific hardware. However, the apparatuses, uses, and methods disclosed herein have been described in a manner sufficient to enable persons of ordinary skill in the art to readily adapt commercially available hardware as may be needed to reduce any of the embodiments of the present invention to practice without undue experimentation.

Following from the above description and invention summaries, it should be apparent to persons of ordinary skill in the art that, while the methods and apparatuses herein described constitute exemplary embodiments of the present invention, it is to be understood that the inventions contained herein are not limited to the above precise embodiments and that changes may be made without departing from the scope of the invention as defined by the claims. Likewise, it is to be understood that the invention is defined by the claims and it is not necessary to meet any or all of the identified advantages or objects of the invention disclosed herein in order to fall within the scope of the claims, since inherent and/or unforeseen advantages of the present invention may exist even though they may not have been explicitly discussed herein.

What is claimed is:

1. A method of repurposing printed content to interact with digital content, the method comprising the steps of:
providing printed content items and digital content items associated with the printed content items, a storage device storing a content database having a plurality of digital content items, an output device for outputting one or more representations of the plurality of digital content items, and an interactive user device for generating one or more signals associated with retrieval of the plurality of digital content items from the storage device based, at least in part, on input of a user, the interactive user device being capable of associating the printed content items with one or more of the digital content items;
accessing a mapping database by the interactive user device, the mapping database having mapping information related to the mapping of printed content items to digital content items;
converting the digital content items to alternate digital content items using a software application;
modifying the mapping information to associate the printed content items with the alternate digital content items in response to, at least in part, input from the user; and
outputting to the output device the alternate digital content items.

2. The method of claim 1, wherein the mapping information includes one of a database file and a database record.

3. The method of claim 1, wherein the digital content items include one or more of audio content, video content, text content, picture content, graphic content, mathematics content, scientific content, sign language content, animation content, email content and Internet content.

4. The method of claim 1, wherein the alternate digital content items include one or more of audio content, video content, text content, picture content, graphic content, mathematics content, scientific content, sign language content, animation content, email content and Internet content.

5. The method of claim 1, wherein the printed content items include icons associated with one or more of audio content, video content, text content, picture content, graphic content, mathematics content, scientific content, sign language content, animation content, email content and Internet content.

6. The method of claim 1, further comprising the step of:
displaying the printed content items within a printed publication, the printed content items including one or more icons.

7. The method of claim 6, wherein the one or more icons include icons associated with one or more of audio content, video content, text content, picture content, graphic content, mathematics content, scientific content, sign language content, animation content, email content and Internet content.

8. A method of repurposing printed content to interact with digital content, the method comprising the steps of:
providing a printed content item and a digital content item, a storage device storing a content database having a digital content item, an output device for outputting one or more representations of the digital content item, a software application for converting the digital content item to an alternate representation of the digital content item, and an interactive user device for generating one or more signals associated with retrieval of the digital content item from the storage device based, at least in part, on input of a user, the interactive user device being capable of associating the printed content item with the digital content item;
associating via a mapping database the printed content item with the digital content item;
initiating by a user the software application to convert the digital content item to the alternate representation of the digital content item;
converting the digital content item to the alternate representation of the digital content item;
modifying the mapping database to associate the printed content item with the alternate representation of the digital content item in response to, at least in part, input from the user; and
outputting to the output device alternate representation of the digital content item.

9. The method of claim 8, wherein the digital content item includes one or more of audio content, video content, text content, picture content, graphic content, mathematics content, scientific content, sign language content, animation content, email content and Internet content.

10. The method of claim 8, wherein the alternate representation of the digital content item includes one or more of audio content, video content, text content, picture content, graphic content, mathematics content, scientific content, sign language content, animation content, email content and Internet content.

11. The method of claim 8, wherein the printed content item includes an icon associated with one or more of audio content, video content, text content, picture content, graphic content, mathematics content, scientific content, sign language content, animation content, email content and Internet content.

12. The method of claim 8, further comprising the step of:
displaying the printed content item within a printed publication, the printed content items including an icon.

13. The method of claim 12, wherein the icon includes an icon associated with one or more of audio content, video content, text content, picture content, graphic content, mathematics content, scientific content, sign language content, animation content, email content and Internet content.

14. A system for repurposing printed content to interact with digital content comprising:
a printed publication having a printed content item;
a storage device for storing a first digital content item and a second digital content item;
a content database adapted to associate the printed content item with the first digital content item, the content database being capable of being modified to re-associate the printed content item with the second digital content item;
an interactive user device adapted to request one or more of the first digital content item and the second digital content item from the content database; and
an output device for outputting a representation of the one or more of the first digital content item and the second digital content item.

15. The system of claim 14, further comprising:
a software tool operating on one of the interactive user device and the output device, the software tool configured to perform the steps of:
associating via the content database the printed content item with the first digital content item; and
modifying the content database to associate the printed content item with the second digital content item.

16. The system of claim 15, wherein the first digital content item includes one or more of audio content, video content, text content, picture content, graphic content, mathematics content, scientific content, sign language content, animation content, email content and Internet content.

17. The system of claim 15, wherein the second digital content item includes one or more of audio content, video content, text content, picture content, graphic content, mathematics content, scientific content, sign language content, animation content, email content and Internet content.

18. The system of claim 15, wherein the printed content item includes an icon associated with one or more of audio content, video content, text content, picture content, graphic content, mathematics content, scientific content, sign language content, animation content, email content and Internet content.

19. A system for repurposing printed content to interact with digital content comprising:
a printed publication having a plurality of printed content items;
a storage device for storing a plurality of digital content items associated with the plurality of printed content items;
a content database for associating each of the plurality of printed content items with each of the plurality of digital content items, the content database being capable of modification to re-associate one of the plurality of printed content items with one of the plurality of digital content items;
an interactive user device adapted to request one or more of the plurality of digital content items from the content database; and
an output device for outputting one or more of the plurality of digital content items.

20. The system of claim 19, further comprising:
a software tool operating on one of the interactive user device and the output device, the software tool configured to perform the steps of:
associating via the content database the plurality of printed content item with the plurality of digital content items; and
modifying the content database to re-associate at least on of the plurality of printed content items with at least one of the plurality of digital content items.

21. The system of claim 19, wherein the plurality of digital content items includes one or more of audio content, video content, text content, picture content, graphic content, mathematics content, scientific content, sign language content, animation content, email content and Internet content.

22. The system of claim 19, wherein the plurality of printed content items include icons associated with one or more of audio content, video content, text content, picture content, graphic content, mathematics content, scientific content, sign language content, animation content, email content and Internet content.
